(19) United States
(12) Patent Application Publication
(10) Pub. No.: US 2019/0392517 A1
(43) Pub. Date: Dec. 26, 2019

(54) GRAPHICAL USER MECHANISM FOR BACK-EVALUATING CREDITING METHODS WITH SELECTIVE REPLACEMENT

(71) Applicant: Bank of America Corporation, Charlotte, NC (US)

(72) Inventors: Jason Zahn, Jersey City, NY (US); Julius M Marapachi, New York, NY (US)

(21) Appl. No.: 16/164,977

(22) Filed: Oct. 19, 2018

Related U.S. Application Data
(63) Continuation-in-part of application No. 16/016,897, filed on Jun. 25, 2018.

(51) Int. Cl. G06Q 40/02; G06Q 40/00; G06Q 40/06

(52) U.S. Cl. CPC G06Q 40/025; G06Q 40/06; G06Q 40/125

(57) ABSTRACT

Aspects of the disclosure relate to apparatus and methods for a graphical user mechanism (“GUM”) for back-evaluating potential crediting methods. The crediting methods may include selective replacement. The GUM may include a first and a second database and a first and a second fusion matrix stored in memory of a computer system. An input/output (“I/O”) component of the computer system may receive a selection of a start date, an end date, and a premium level. A processor of the computer system may calculate percentage yields based on the databases, the fusion matrices, and the selections. The GUM may display the resultant percentage yields in graphical format on a display of the computer system for easy evaluation. The GUM may receive additional selections, and, in response to a trigger, calculate and display updated results.

### CROSS-REFERENCE TO RELATED APPLICATION

This application is a continuation-in-part application of non-provisional U.S. patent application Ser. No. 16/016,897, entitled, “GRAPHICAL USER MECHANISM FOR BACK-EVALUATING POTENTIAL CREDITING METHODS”.

### FIELD OF TECHNOLOGY

Aspects of the disclosure relate to graphical user mechanisms. More particularly, the disclosure relates to graphical user mechanisms for back-evaluating crediting methods and artificial intelligence relating to same.

### BACKGROUND OF THE DISCLOSURE

Fixed Index Annuity (“FIA”) sales have grown rapidly over the past number of years. This product has priced favorably especially in view of insurers shifting their product line to lower risk offerings.

Although there has been an exponential growth recently in FIA sales, there has been limited development from the crediting method perspective (outside of use of custom target volatility indices as underlying crediting options). The interest-crediting method determines how interest changes to a fixed index annuity (FIA) are measured. The selected interest-crediting method determines the amount of interest that the annuity holder can receive over a specific time period. Annuity contracts have a number of provisions that affect how interest is treated. Most contacts include a combination of caps (maximum interest allowed), participation rates (fraction of interest credited to the contract) and spreads. These limit the upside potential of increases in index value.

FIG. 1 shows a rendering of various crediting methods for FIAs for a specific historic period. Specifically, FIG. 1 shows a chart regarding the market share of various crediting methods in the first quarter of 2017. Term-End Point (TEP), shown at 102, is a conventional method of crediting an annuity. TEP determines index-linked interest, if any, based on the difference between the index value at the end of the term and the index value at the start of the term. Interest is typically added to the annuity at the end of the term. Term-End Point captured a 13.3% market share in Q1 of 2017.

A-PTP (Annual Point-to-Point), as shown at 104, is a point-to-point crediting method. Point-to-point 104 is the method of using points in time for that index as the basis of credited interest. In this case, the difference between the starting-date balance and the ending-date balance is used to credit interest. So, if the annuity earns interest based on the movement of the S&P 500, and the index is at 1,000 at the beginning of the time period and 1,100 at the end, the increase would be 10%. The difference is 100, which equals 10% of the starting value.

Point-to-point 104 itself refers to two different points in time. While annuities are most commonly calculated annually, it's possible to use the point-to-point method with any type of periodic interest set up (M-PTP 108 below). It should be noted that this method is calculated prior to the application of any caps, spreads, or participation rates, which limit or reduce the amount of interest your annuity will actually be credited. FIG. 1 shows that point-to-point 104 captured a 44.2% market share in Q1 of 2017.

A daily average interest credit (which can also be considered as a paradigmatic case of other period averages, such as weekly, monthly, etc.) (shown schematically as an average value at 106 which captured a 7.3% market share in Q1 of 2017) is calculated by subtracting the beginning index value from the daily average index value. The daily average index value equals the sum of the index values over the contract year, excluding the beginning index value, divided by the number of index values available for the contract year. The beginning index value equals the index value on the first day of the contract year. The difference is then divided by the beginning index value to determine the percent of index value change. This percent can either be positive or negative. Once the percent of index value is determined it will then be subject to either a participation rate, index cap rate or a combination of any of the above. The resulting final percentage is the percentage of interest credited at the contract anniversary. It is important to remember that the interest credit percentage will not exactly equal the performance of the chosen index option(s).

M-PTP (Monthly Point-to-Point) is another form of point-to-point crediting method, as shown at 108. M-PTP captured a 10.1% market share during Q1 of 2017. This method may also be referred to as a monthly-sum cap and will be described in more detail below.

A fixed return annuity contract, as shown at 110, provides a guaranteed minimum interest rate and a higher current interest rate for shorter time periods during a deferred annuity's accumulation phase. Fixed 110 captured a 17.4% market share during Q1 of 2017. Finally, other 112 shows that alternative methods of crediting captured about a 7.7% market share during Q1 of 2017.

As seen from FIG. 1, there are numerous different types of crediting methods for FIAs.

It would be desirable to develop systems and methods that enable a user to use a testing platform to evaluate historic performance of innovative crediting methods.

It would be yet further desirable to use artificial intelligence (AI) to help determine the most efficient, and preferably reduced-resource-consumptive, methods for crediting FIAs.

It would be still further desirable to enable a user to access the AI whereby the user can leverage the AI to develop methods for crediting FIAs.

### SUMMARY OF THE DISCLOSURE

A graphical user mechanism (“GUM”) for back-evaluating potential crediting methods is provided. The GUM may include a first and a second database stored in a non-transitory memory. The first database may include a set of historical financial data mapped to a set of dates. The second database may include a set of premiums, a first set of replacement values, and a second set of replacement values. The first and second sets of replacement values may each be mapped to the set of premiums in the database. // The term “replacement values” as used herein may refer to cap values (i.e., values that replace an actual value only if the replacement value is less than the actual value), or set replacement values (i.e., values that replace an actual value even if the replacement value is greater than the actual value).

The GUM may also include a first and a second fusion matrix stored in the non-transitory memory. Each fusion matrix may be for determining a final percentage yield (“y_{f}”) based on a premium, a first date, and a second date. Each fusion matrix may use predetermined rules, equations, and data for the determination. The first fusion matrix may use the first set of replacement values as part of the determination. The second fusion matrix may use the second set of replacement values as part of the determination.

The GUM may be configured to receive, via an input/output (“I/O”) component, a first selected premium. The first selected premium may be selected by a user from the set of premiums. The GUM may also receive a first start date (“t₀”) and a first end date (“t₁”). The first to and the first t₁ may be selected from the set of dates.

The GUM may be configured to calculate, via a processor, a first y_{f} as determined by the first fusion matrix. The calculation may use the first selected premium, the first t₀, and the first t₁.

The GUM may be further configured to calculate, via the processor, a second y_{f} as determined by the second fusion matrix. The calculation may use the first selected premium, the first t₀, and the first t₁.

The GUM may be further configured to present a graph, on a graphical display, showing the first y_{f} and the second y_{f} as a function of the first selected premium, the first t₀, and the first t₁. The graph may be in table form. The graph may be one or more plots. The graph may include multiple values. The multiple values may represent averages, minimums, maximums, or any other suitable values that may be useful for back-evaluation.

The GUM may be further configured to receive, via the I/O component: a second selected premium, a second t₀, and a second t₁. In response to a predetermined trigger, the GUM may calculate, via the processor, a third y_{f} as determined by the first fusion matrix, using the second selected premium, the second t₀, and the second t₁. The GUM may also calculate, via the processor, a fourth y_{f} as determined by the second fusion matrix, using the second selected premium, the second t₀, and the second t₁. The GUM may also update the graph, to show the third y_{f} and the fourth y_{f} as a function of the second selected premium, the second t₀, and the second t₁.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows a rendering of respective market shares associated with various crediting methods for FIAs for a specific historic period;

FIG. 2 shows an illustrative system for use in accordance with principles of the disclosure;

FIG. 3 shows another illustrative system for use in accordance with principles of the disclosure;

FIG. 4 shows another illustrative bar chart in accordance with principles of the disclosure;

FIG. 5 shows a table indicating a historical rendering in accordance with principles of the disclosure;

FIG. 6 shows another table indicating a historical rendering in accordance with principles of the disclosure;

FIG. 7A shows yet another table indicating a historical rendering in accordance with principles of the disclosure;

FIG. 7B shows another table indicating a historical rendering in accordance with principles of the disclosure;

FIG. 8 shows still another table indicating a historical rendering in accordance with principles of the disclosure; and

FIG. 9 shows an illustrative system for use in accordance with principles of the disclosure.

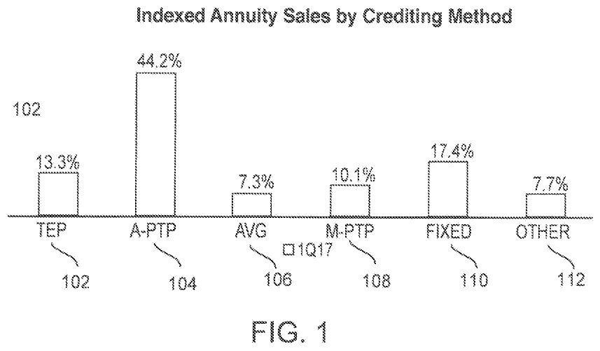

### DETAILED DESCRIPTION OF THE DISCLOSURE

Much room exists to innovate crediting methods that are attractive from a sales, budgeting and client experience perspective.

A monthly-sum cap takes the percentage increase or decrease in the index each month and sums them up. The index may go into positive territory or fall into negative territory from month-to-month. If the percentages are added together and come out positive, then the interest will be credited to the contract. This method is the most sensitive to volatility for the reasons that follow. Because the months are typically capped—i.e., the gain from a single month is limited to a pre-determined percentage—and the caps are traditionally low—e.g., such as 1.00% —the payout is limited and vulnerable to having potential returns wiped out during any significant down month or months. This is true even when the remaining, or other, months are positive.

Accordingly, some aspects of the invention relate to an alternative crediting methodology that preferably mitigates the cap limitations of the current monthly-sum cap structure. These aspects preferably complement the currently-available crediting methods.

The disclosure is designed to address two of the major shortcomings of existing crediting options in the conventional monthly-sum cap FIA market. Specifically, the disclosure is designed to address the capped upside of the FIA market as well as the vulnerability of having potential returns wiped out during any significant down month.

The embodiments herein provide a crediting methodology including a strategy that allows for uncapped potential index crediting, and also provides the opportunity to regain positive interest crediting where a traditional monthly-sum cap may have been significantly, and irreversibly, reduced. Moreover, historical tests performing by back- evaluating potential crediting using the embodiments, have shown that average and maximum returns associated with the embodiments have out-performed traditional monthly-sum cap methods.

One aspect of the embodiments is that the end user elects to relinquish the returns of a pre-determined number of the highest performing months to receive a pre-defined credit for the relinquished months. The pre-defined credit may be a cap value, i.e., the minimum of the return for the month and a preset cap. In some embodiments, the pre-defined credit may be a set replacement value to replace the actual return value, whether the return was greater or less than the replacement value. The quid pro quo for the relinquished months is that the user receives uncapped gains for the remainder of the months. This methodology may be referred to herein as a Selective Replacement methodology.

Certain embodiments operate as follows: On the contract anniversary each month, the index value of the option basket (or other group of investment instruments) is compared to the prior month's value, and the ratio of these two values is calculated.

At the end of the year, the contract's monthly ratios are multiplied. The pre-determined number of best ratios (such as two or three best ratios) are replaced by some predetermined number such as 101% percent—i.e., 101/100. If the final product of all the months is greater than a threshold value of 100%, the end user receives the difference as indexed interest on the FIA. If the final product is lower than 100%, the user receives no, or substantially no, indexed interest.

In some embodiments, 100% may be subtracted from each monthly ratio (that may have been multiplied by 100 to convert to percentage form) to yield a monthly return percentage. At the end of the year, the predetermined number of best monthly returns (such as the two or three best monthly returns) are replaced by a predetermined replacement percentage, such as 1%. The replacement percentage may be a cap value or a set replacement value. The 12 percentages may be summed. If the final product of all the months is greater than a threshold value of 0%, the end user receives the difference as indexed interest on the FIA. If the final product is lower than 0%, the user receives no, or substantially no, indexed interest.

A graphical user mechanism (“GUM”) for back-evaluating potential crediting methods is provided. The GUM may include a first and a second database stored in a non-transitory memory. The first database may include a set of historical financial data mapped to a set of dates. The second database may include a set of premiums, a first set of replacement values, and a second set of replacement values. The replacement values may be cap values (i.e., values that can only be used to replace a larger value) or set replacement values (i.e., values that can be used to replace any value). The first and second sets of replacement values may each be mapped to the set of premiums in the database.

Table 1 below shows exemplary portions of an illustrative database including a set of historical financial data mapped to a set of dates. In the exemplary database shown in Table 1, the set of dates may cover the time period from Jan. 3, 2000 until Jun. 18, 2018. The financial data may represent the closing index value of the S&P 500 index for each particular day.

TABLE 1
Illustrative database

| | Closing | |
|---|---|---|
| Date | Index | |
| Jan. 3, 2000 | 1455.22 | 1 |
| Jan. 4, 2000 | 1399.42 | 2 |
| Jan. 5, 2000 | 1402.11 | 3 |
| Jan. 6, 2000 | 1403.45 | 4 |
| Jan. 7, 2000 | 1441.47 | 5 |
| Jan. 10, 2000 | 1457.6 | 6 |
| Jan. 11, 2000 | 1438.56 | 7 |
| Jan. 12, 2000 | 1432.25 | 8 |
| Jan. 13, 2000 | 1449.68 | 9 |
| Jan. 14, 2000 | 1465.15 | 10 |
| Jan. 18, 2000 | 1455.14 | 11 |
| Jan. 19, 2000 | 1455.9 | 12 |
| Jan. 20, 2000 | 1445.57 | 13 |
| Jan. 21, 2000 | 1441.36 | 14 |
| Jan. 24, 2000 | 1401.53 | 15 |
| Jan. 25, 2000 | 1410.03 | 16 |
| Jan. 26, 2000 | 1404.09 | 17 |
| Jan. 27, 2000 | 1398.56 | 18 |
| Jan. 28, 2000 | 1360.16 | 19 |
| Jan. 31, 2000 | 1394.46 | 20 |
| Feb. 1, 2000 | 1409.28 | 21 |
| Feb. 2, 2000 | 1409.12 | 22 |
| . . . | . . . | . . . |
| Jun. 1, 2018 | 2734.62 | 4633 |
| Jun. 4, 2018 | 2746.87 | 4634 |
| Jun. 5, 2018 | 2748.8 | 4635 |
| Jun. 6, 2018 | 2772.35 | 4636 |
| Jun. 7, 2018 | 2770.37 | 4637 |
| Jun. 8, 2018 | 2779.03 | 4638 |
| Jun. 11, 2018 | 2782 | 4639 |
| Jun. 12, 2018 | 2786.85 | 4640 |
| Jun. 13, 2018 | 2775.63 | 4641 |
| Jun. 14, 2018 | 2782.49 | 4642 |
| Jun. 15, 2018 | 2779.66 | 4643 |
| Jun. 16, 2018 | 2771.74 | 4644 |

Table 2 below shows exemplary portions of an illustrative database. The exemplary database shown in Table 2 may include a set of premiums, a first set of replacement values, and a second set of replacement values. The first and second sets of replacement values may each be mapped to the set of premiums in the database.

TABLE 2
Illustrative database

| | Selective | |
|---|---|---|
| | Replacement | Classic Cliquet |
| Premium | Value | Cap |
| 1.30% | 0.20% | 1.15% |
| 1.50% | 0.40% | 1.25% |
| 1.75% | 0.75% | 1.40% |
| 2.00% | 1.00% | 1.55% |
| 2.25% | 1.25% | 1.70% |

The GUM may also include a first and a second fusion matrix stored in the non-transitory memory. Each fusion matrix may be for determining a final percentage yield (“y_{f}”) based on a premium, a first date, and a second date. Each fusion matrix may use predetermined rules, equations, and data for the determination. The first fusion matrix may use the first set of replacement values as part of the determination. The second fusion matrix may use the second set of replacement values as part of the determination.

The GUM may be configured to receive, via an input/output (“I/O”) component, a first selected premium. The first selected premium may be selected by a user from the set of premiums. The GUM may also receive a first start date (“t₀”) and a first end date (“t₁”). The first to and the first t₁ may be selected from the set of dates.

The GUM may be configured to calculate, via a processor, a first y_{f} as determined by the first fusion matrix. The calculation may use the first selected premium, the first t₀, and the first t₁.

The GUM may be further configured to calculate, via the processor, a second y_{f} as determined by the second fusion matrix. The calculation may use the first selected premium, the first t₀, and the first t₁.

The GUM may be further configured to present a graph, on a graphical display, showing the first y_{f} and the second y_{f} as a function of the first selected premium, the first t₀, and the first t₁. The graph may be in table form. The graph may be one or more plots. The graph may include multiple values. The multiple values may represent averages, minimums, maximums, or any other suitable values that may be useful for back-evaluation.

The GUM may be further configured to receive, via the I/O component: a second selected premium, a second t₀, and a second t₁. In response to a predetermined trigger, the GUM may calculate, via the processor, a third y_{f} as determined by the first fusion matrix, using the second selected premium, the second t₀, and the second t₁. The GUM may also calculate, via the processor, a fourth y_{f} as determined by the second fusion matrix, using the second selected premium, the second t₀, and the second t₁. The GUM may also update the graph, to show the third y_{f} and the fourth y_{f} as a function of the second selected premium, the second t₀, and the second t₁.

The GUM may be configured to substantially continuously run. The GUM may constantly and indefinitely perform calculations and update the graphical display to respond to additional selections and triggers.

In certain embodiments of the GUM, the first and second fusion matrices may include a monthly point-to-point (“M-PTP”) crediting method. In a M-PTP, a monthly return value (“r[t]”) for a given month (“t”) out of a 12-month period may be calculated. The calculation may include dividing an index value at a valuation date of the given month by an index value at a valuation date of the month before the given month to yield a ratio. 100% may be subtracted from the ratio (subtracting a percentage from a ratio may inherently indicate that the ration is multiplied by 100 to convert to percentage form) to yield a monthly return value. Each valuation date may be a predetermined monthly anniversary date. The index value at a valuation date may be the value of a predetermined financial index at closing on the valuation date. The calculation for said r[t] may be at least in part represented by the equation:

$$r [ t ] = \frac{{Index}_{t}}{{Index}_{t - 1}} - 100 \% .$$

In certain embodiments of the GUM, the first fusion matrix may further include a “Cliquet” capping methodology. A Cliquet capping methodology may be a classic, conventional, methodology for capping in a M-PTP crediting method.

The Cliquet capping methodology may include updating a set comprising the monthly return values of each month of the 12-month period. The updating may include replacing, each monthly return value in the set that is above a predetermined replacement value, with the replacement value. The Cliquet capping methodology may further include summing the values in the updated set to yield a total percentage. The greater of 0% and the total percentage may equal y_{f}.

In some embodiments, the first fusion matrix may incorporate Cliquet in determining y_{f}. The first fusion matrix may determine y_{f} at least in part using the following equation (where Cap=the predetermined replacement value):

y_{f}=Max(Σₜ₌₁¹² min[Cap,r[t]],0)

In certain embodiments, the Cliquet capping methodology may include multiplying the monthly ratios to yield a total ratio. Any month with a ratio above a predetermined replacement ratio may be replaced with the replacement ratio.

In certain embodiments of the GUM, the second fusion matrix may include a “Selective Replacement” methodology. A Selective Replacement methodology may be a novel methodology for capping and/or replacing in a M-PTP crediting method.

The Selective Replacement methodology may include updating a set comprising the monthly return values of each month of the 12-month period. The updating may include replacing, a predetermined number of the highest monthly return values in the set that are above a predetermined replacement value, with the replacement value. The term “replacement value” as used herein may refer to a cap value, i.e., the minimum of the return for the month and a preset cap. Alternatively, the term “replacement value” may refer to a set replacement value to replace the actual return value, whether the return was greater than or less than the replacement value. When the replacement value is a cap value, the methodology may be referred to herein as a “Selective Capping methodology.” The term “Selective Replacement methodology” may be used herein as a general term to refer to a Selective Replacement methodology with a set replacement value or a Selective Capping methodology with a cap value.

The Selective Replacement methodology may further include summing the values in the updated set to yield a total percentage, and determining y_{f} as the greater of 0% and the total percentage.

In some embodiments, the second fusion matrix may incorporate Selective Replacement with cap values in determining y_{f}. The second fusion matrix may determine y_{f} at least in part using the following equation (where r_ranked(t) represents each monthly return as ranked in ascending order, NOC is the number of caps that replace monthly returns, and Cap is the predetermined replacement value):

y_{f}=Max(Σₜ₌₁^{12-NOC}r_ranked(t)+Σ_{t=13-NOC}¹²min[Cap,r_ranked(t)],0)

In some embodiments, the second fusion matrix may incorporate Selective Replacement with set replacement values in determining y_{f}. The second fusion matrix may determine y_{f} at least in part using the following equation (where r_ranked(t) represents each monthly return as ranked in ascending order, NOR is the number of replacements that replace monthly returns and RL is the replacement level, or the set replacement value):

y_{f}=Max(Σₜ₌₁^{12-NOR}r_ranked(t)+RL×NOR,0)

In certain embodiments of the GUM, the processor may calculate each y_{f} in real-time. In some embodiments of the GUM, the processor may pre-calculate at least some of the values used to calculate each y_{f}. Pre-calculating some values may include producing additional databases for referential use. Existence of additional databases may lower a latency of the GUM calculation process.

In some embodiments, the GUM may further include a refresh button on the graphical display. The refresh button may be selectable. Selecting the refresh button may include clicking on the refresh button with a cursor, touching the refresh button on a touch-enabled screen, or any suitable mechanism. The predetermined trigger may include selecting the refresh button. The predetermined trigger may include any other suitable triggering mechanism.

In certain embodiments of the GUM, the graph on the graphical display may include a first column containing values associated with the first fusion matrix, and a second column containing values associated with the second fusion matrix.

In some embodiments of the GUM, the graph on the graphical display may further include a first row containing average values, a second row containing minimum values, and a third row containing maximum values.

In certain embodiments, the GUM may further include an intelligent module. The intelligent module may use artificial intelligence technology to analyze the data in the databases to determine a current preferred selection between the first fusion matrix and the second fusion matrix. The preferred selection may assist a user in selecting a crediting method. The intelligence module may also be configured to construct rules and equations for a new fusion matrix that is not the first or second fusion matrix. The new fusion matrix may use a new capping methodology and/or crediting method.

In certain embodiments, the methodology may span a 12-month period. The 12-month period may begin on an initial valuation date. The initial valuation date may be a strike date. A valuation date may be represented herein by the variable “t”. The initial valuation date may be t=0. The 12 subsequent valuation dates (to be referred to as herein as t=1 through t=12) are the monthly anniversaries of t=0 over the subsequent 12 months. For example, if t=0 is Jun. 6, 2018, then t=1, t=2, . . . t=12, are Jul. 6, 2018, Aug. 6, 2018, . . . Jun. 6, 2019 respectively.

A monthly return (alternatively referred to herein as “r[t]”) may be a calculation of a percentage rate of return a valuation date of a given month. A calculation for r[t] may include: Take an index of a valuation date t (“Indexₜ”). Indexₜ may represent an official closing level of an underlying index on the valuation date t. An index may be associated with any suitable underlying financial index, such as an index associated with the Dow Jones Industrial Average, or the Standard & Poor's 500. Divide the index at valuation date t by the index at valuation date t−1. Subtract 100% from the result of the division (the result may be first multiplied by 100 to convert to percentage form), and the resultant percentage is the monthly return for valuation date t. The above-described calculation may be represented in equation form as follows:

$$r [ t ] = \frac{{Index}_{t}}{{Index}_{t - 1}} - 100 \%$$

In one embodiment of the Selective Replacement methodology, a number of caps (“NOC”) may be selected. The NOC may be the number of the highest performing months (months with the highest monthly return) for which the monthly return will be replaced by the replacement value that is a cap value. Typical NOCs associated with the Selective Replacement methodology may be 2 or 3.

A percentage value for the cap may also be selected. The percentage value for cap is the value that will replace the monthly return values for the top NOC of the highest performing months. The cap may only replace the monthly return if the cap is less than the monthly return. Exemplary caps may include 0.25%, 0.3%, 0.5%, 1%, or any other suitable percentage.

In another embodiment of the Selective Replacement methodology, a number of replacements (“NOR”) may be selected. The NOR may be the number of the highest performing months (months with the highest monthly return) for which the monthly return will be replaced by a set replacement value. Typical NORs associated with the Selective Replacement methodology may be 2 or 3.

A percentage value for the set replacement value may also be selected. The percentage value for set replacement value (the replacement level, or “RL”) is the value that will replace the monthly return values for the top NOR of the highest performing months. The set replacement value may replace the monthly return even if the set replacement value is more than the monthly return. Exemplary RLs may include 0.25%, 0.3%, 0.5%, 1%, or any other suitable percentage.

At the end of the 12-month period, a settlement amount may be calculated. The settlement amount may be calculated on the valuation date t=12. Valuation date t=12 may alternatively be referred to as the final valuation date, or the cash settlement payment date.

In one embodiment, the settlement amount may be calculated as follows: Calculate the monthly return for the 12 valuation dates from t=1 through t=12. Replace the top NOC number (for example the top 2 if NOC=2) of the monthly returns with the replacement value, but only if the monthly return is higher than the replacement value. (i.e., for the top NOC monthly returns, take the lower of the monthly return and the cap.) Calculate a summation of the above values. The resultant percentage is the settlement percentage, or y_{f}. If the resultant percentage is below 0%, the settlement percentage may remain 0%. Finally, multiplying a predetermined notional value by the settlement percentage yields the settlement amount. The above-described calculation may be represented in equation form as follows (with r_ranked(t) representing each monthly return as ranked in ascending order):

Settlement amount=Notional×Max(Σₜ₌₁^{12-NOC}r_ranked(t)+Σ_{t=13-NOC}¹²min[Cap,r_ranked(t)],0)

Alternatively, replace the top NOR number of the monthly returns with the replacement value (RL), even if the replacement value is greater than the monthly return. The above-described calculation may be represented in equation form as follows (with r_ranked(t) representing each monthly return as ranked in ascending order):

Settlement amount=Notional×Max(Σₜ₌₁^{12-NOR}r_ranked(t)+RL×NOR,0)

In some embodiments, the GUM may be configured to include more than two fusion matrices. The GUM may also display more than two y_{fS}. Displaying more than two y_{fS} may provide comparison of more than two methodologies. A GUM may also be configured to calculate and display y_{fS} with any fusion matrices based on any suitable methodologies.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

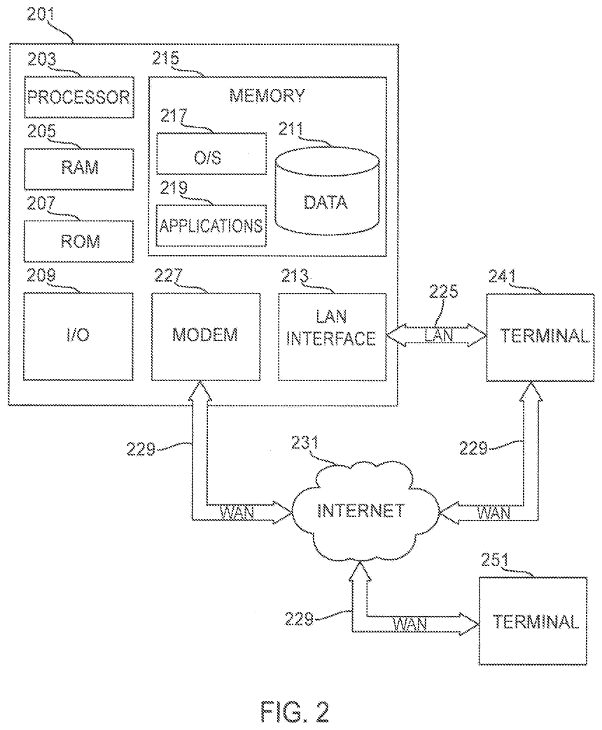

FIG. 2 shows an illustrative system for use in accordance with principles of the disclosure. FIG. 2 is an illustrative block diagram of mobile, or other, device system 200 based on a computer 201. The computer 201 may have a processor 203 for controlling the operation of the mobile device and its associated components, and may include RAM 205, ROM 207, input/output module 209, and a memory 215. The processor 203 will also execute all software running on the computer—e.g., the operating system. Other components commonly used for computers such as EEPROM or Flash memory or any other suitable components may also be part of the computer 201.

The memory 215 may be comprised of any suitable permanent storage technology—e.g., a hard drive. The memory 215 stores software including the operating system 217 any application(s) 219 along with any data 211 needed for the operation of the system 200. Alternatively, some or all of computer executable instructions may be embodied in hardware or firmware (not shown). The computer 201 executes the instructions embodied by the software to perform various functions.

Input/output (“I/O”) module may include connectivity to a microphone, keyboard, touch screen, and/or stylus through which a user of computer 201 may provide input, and may also include one or more speakers for providing audio output and a video display device for providing textual, audiovisual and/or graphical output.

System 200 may be connected to other mobile device systems via a LAN interface 213.

System 200 may operate in a networked environment supporting connections to one or more remote computers, such as terminals 241 and 251. Terminals 241 and 251 may be personal computers or servers that include many or all of the elements described above relative to mobile device system 200. The network connections depicted in FIG. 2 include a local area network (LAN) 225 and a wide area network (WAN) 229, but may also include other networks. When used in a LAN networking environment, computer 201 is connected to LAN 225 through a LAN interface or adapter 213. When used in a WAN networking environment, computer 201 may include a modem 227 or other means for establishing communications over WAN 229, such as Internet 231.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program(s) 219, which may be used by computer 201, may include computer executable instructions for invoking user functionality related to communication, such as email, Short Message Service (SMS), and voice input and speech recognition applications.

Computer 201 and/or terminals 241 or 251 may also be mobile devices including various other components, such as a battery, speaker, and antennas (not shown).

Terminal 251 and/or terminal 241 may be portable devices such as a laptop, cell phone, Blackberry™, or any other suitable device for storing, transmitting and/or transporting relevant information. Terminals 251 and/or terminal 241 may be other mobile devices. These mobile devices may be identical to mobile device system 200 or different. The differences may be related to hardware components and/or software components.

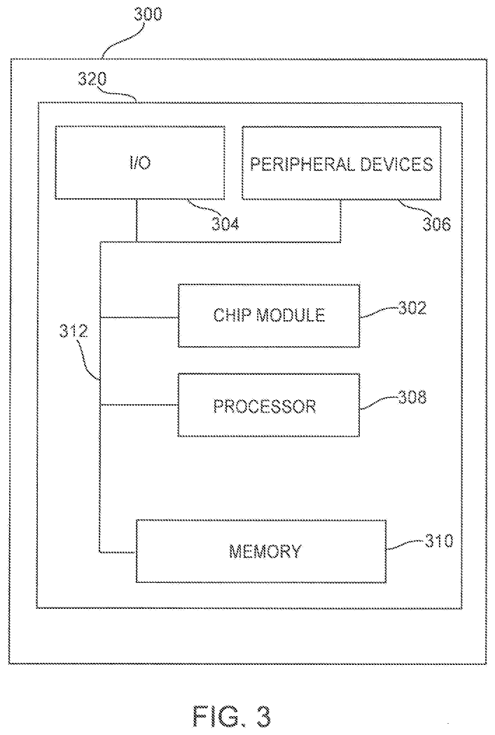

FIG. 3 shows another illustrative system for use in accordance with principles of the disclosure. Apparatus 300 may be a computing machine. Apparatus 300 may include one or more features of the system shown in FIG. 2. Apparatus 300 may include chip module 302, which may include one or more integrated circuits, and which may include logic configured to perform any other suitable logical operations.

Apparatus 300 may include one or more of the following components: I/O circuitry 304, which may include a transmitter device and a receiver device and may interface with fiber optic cable, coaxial cable, telephone lines, wireless devices, PHY layer hardware, a keypad/display control device or any other suitable encoded media or devices; peripheral devices 306, which may include counter timers, real-time timers, power-on reset generators or any other suitable peripheral devices; logical processing device 308, which may compute data structural information, structural parameters of the data, quantify indices; and machine-readable memory 310.

Machine-readable memory 310 may be configured to store in machine-readable data structures: dynamic transaction authorization numbers, the current time, information pertaining to a credit or debit card user and any other suitable information or data structures.

Components 302, 304, 306, 308 and 310 may be coupled together by a system bus or other interconnections 312 and may be present on one or more circuit boards such as 320. In some embodiments, the components may be integrated into a single chip. The chip may be silicon-based.

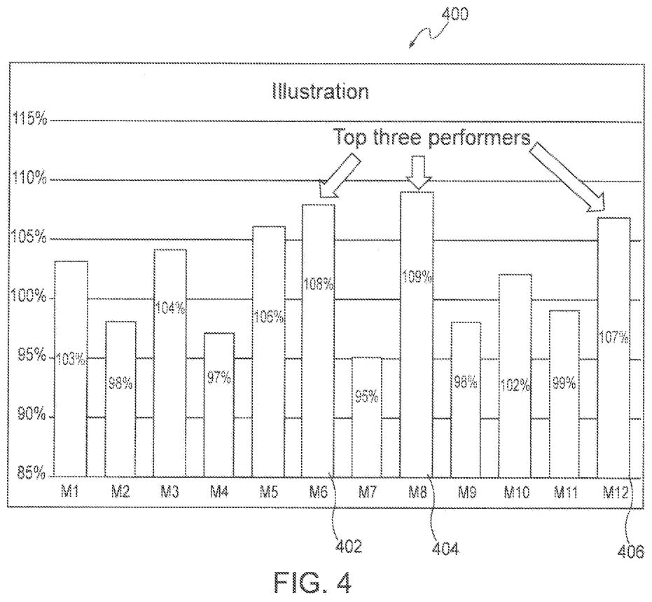

FIG. 4 shows an illustrative bar chart 400 in accordance with principles of the disclosure. Bar chart 400 is an illustration of 12 months of performance of a monthly sum cap FIA. Each of the 12 months is associated with an exemplary return ratio over the previous month. The months with the three highest returns are M6, M8 and M12. M6 shows a return of 108%, M8 shows a return of 109%, and M12 shows a return of 107%. Methods according to the disclosure might replace the returns for months M6, M8 and M12 with a replacement value (e.g., 101%). Then, the values for the months (in decimal form, or percentage divided by 100) can be multiplied to obtain a final index. In this illustration, the final index value would be 1.045 or 4.5% interest over the year.

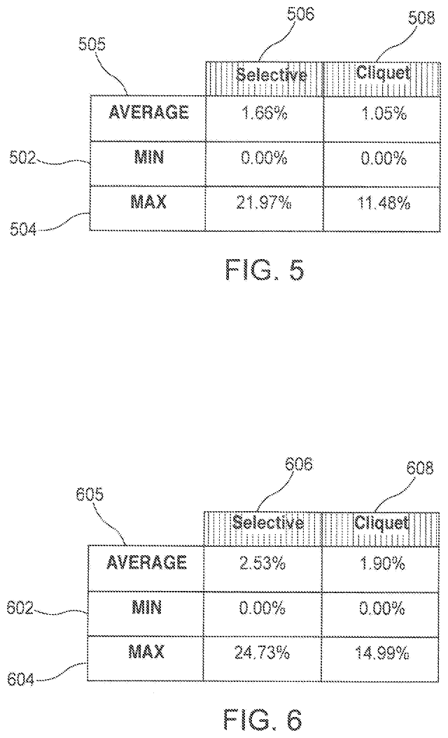

FIG. 5 shows a table indicating a historical rendering in accordance with principles of the disclosure. Specifically, the table in FIG. 5 corresponds to a historical rendering of an ATM Call Option. The rendering uses data from Jan. 3, 2000 until Jun. 14, 2017.

The rendering shown in FIG. 5 compares the Selective Replacement 506 method of monthly-sum cap indexing, according to certain embodiments, to the conventional “cliquet” 508 method of monthly-sum cap indexing. The method according to the disclosures replaces the three top monthly observations by 100.25% and the traditional cliquet includes a very similar equivalent monthly cap of 1.15%.

Historically, the table shows that, at 505, the average annual return for the Selective Replacement 506 over the period was 1.66% and the average annual cliquet 508 return over the period was 1.05%. The minimum annual return, at 502, for both methods was 0.00%. The maximum annual return, at 504, for the Selective Replacement 506 over the period was 21.97% and the maximum annual cliquet 508 return over the period was 11.48%.

Historically over the period of time Selective Replacement paid equal or greater than the cliquet in 88% of cases. Focusing on the dates when the cliquet payout was >0%, the Selective Replacement paid greater in 61% percent of the cases.

Focusing on the dates when Selective Replacement payout was >0%, the Selective Replacement paid greater in 71% of the cases.

Focusing on the dates when either the cliquet or Selective Replacement payout was >0%, Selective Replacement paid greater in 66% of cases.

FIG. 6 shows another table indicating a historical rendering in accordance with principles of the disclosure. The rendering for the table shown in FIG. 6 also uses data from Jan. 3, 2000 until Jun. 14, 2017. The method according to the disclosures replaces the three top monthly observations by 101% and the traditional cliquet includes a very similar equivalent monthly cap of 1.55%.

Historically, the table shows that, at 605, the average annual return for the Selective Replacement 606 over the period was 2.53% and the average annual cliquet 608 return over the period was 1.90%. The minimum annual return, at 602, for both methods was 0.00%. The maximum annual return, at 604, for the Selective Replacement 606 over the period was 24.73% and the maximum annual cliquet 608 return over the period was 14.99%.

Historically over the period of time Selective Replacement paid equal or greater than the cliquet in 83% of cases. Focusing on the dates when the cliquet payout was >0%, the Selective Replacement paid greater in 55.89% percent of the cases.

Focusing on the dates when Selective Replacement payout was >0%, the Selective Replacement paid greater in 63.95% of the cases.

Focusing on the dates when either the Cliquet or Selective Replacement payout was >0%, Selective Replacement paid greater in 63.57% of cases.

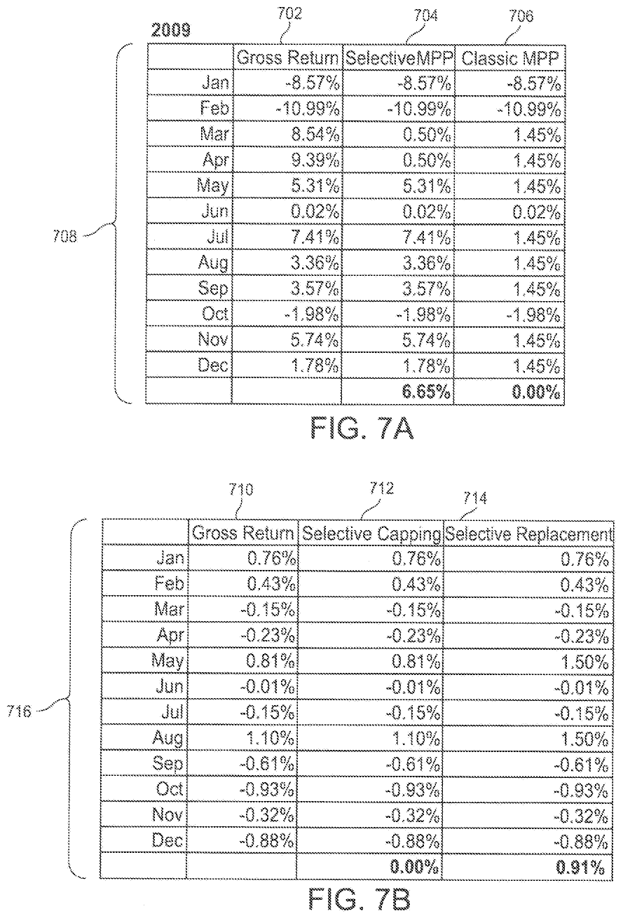

FIG. 7A shows yet another table indicating a historical rendering in accordance with principles of the disclosure. In the table shown in FIG. 7A, instead of capping all months at 1.45%, only the best two months were capped—this time at 0.50%—the other ten months were uncapped.

Column 708 shows months for the year 2009 in which the data was analyzed. Column 702 shows the gross return on a monthly basis. Column 704 shows the Selective Replacement returns. Column 706 shows the returns for the classic monthly-sum capped crediting method.

The summation line at the bottom of column 704 shows that the Selective Replacement crediting method returned 6.65% over 2009. The summation line at the bottom of column 706 shows that the “classic” (conventional) crediting method returned 0.00% over 2009.

FIG. 7B shows another table indicating a historical rendering in accordance with principles of the disclosure. The values in the table are fictional, and for the purpose of illustration. The number of caps (or replacements) in the table is two. Column 710 shows the gross return on a monthly basis, for each of the 12 months of the year shown in column 716.

The table shown in FIG. 7B compares the returns for two embodiments of a Selective Replacement methodology, shown in columns 712 and 714. Column 712 shows a “Selective Capping” methodology that uses a cap value, in this case 1.5%. The cap value may be substituted for two actual monthly returns, but only if the cap value is less than the monthly return. In contrast, Column 714 shows a Selective Replacement methodology that uses a set replacement value, in this case also 1.5%. The replacement value may be substituted for two actual monthly returns, even if the replacement value is greater than the monthly return.

The summation line at the bottom of column 712 shows that the Selective Capping methodology returned 0.00% over the year. The summation line at the bottom of column 714 shows that the Selective Replacement methodology returned 0.91% over the year.

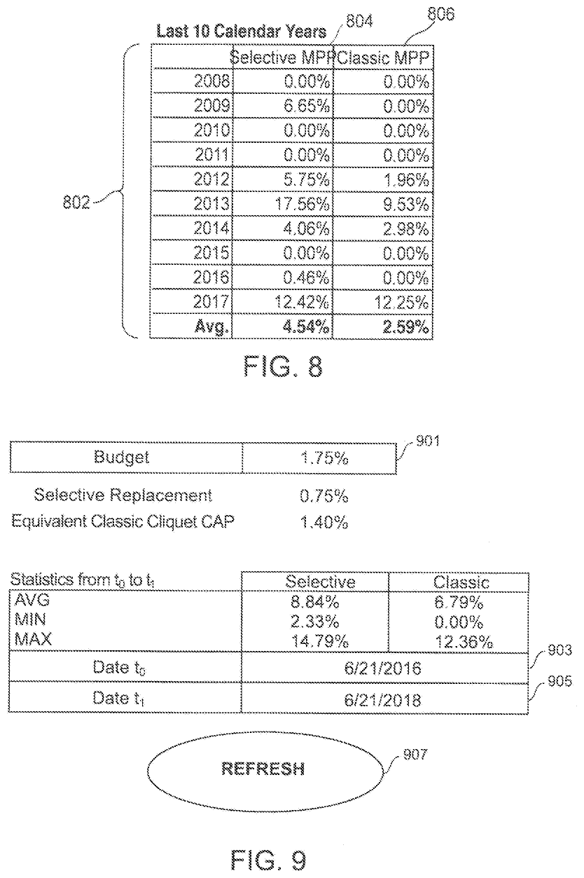

FIG. 8 shows still another table indicating a historical rendering in accordance with principles of the disclosure. The rendering in FIG. 8 covers the years 2008-2017. Column 802 shows the years being analyzed. Column 804 shows the return for the Selective Replacement embodiments and column 806 shows the returns using the “classic” (conventional) crediting method. The average return of the Selective Replacement embodiments was 4.54% while the average return of the conventional embodiments was 2.59%.

FIG. 9 shows an illustrative GUM system display. Box 901 may be an input field for a premium amount. Immediately below box 901 the GUM may display replacement values for Selective Replacement and Cliquet that are mapped to the selected premium amount. In this example, for a premium amount of 1.75%, a cap of 1.40% is used for Cliquet, and a cap of 0.75% is used for Selective Replacement.

Box 903 may be an input field for a start date. Box 905 may be an input field for an end date. Button 907 may be a refresh button that is selectable by a user. When a user inputs a start date in box 903, an end date in box 905, and selects refresh button 907, the GUM may calculate and display result values.

In certain embodiments, the result values may be arranged in table form as shown in FIG. 9. Result values associated with the classic Cliquet capping may be arranged in a column beneath the header “Classic.” Result values associated with the Selective Replacement methodology may be arranged in a column beneath the header “Selective.”

FIG. 9 may show an illustrative GUM display as a table. A table may be alternatively referred to herein as a graph. A graph may also refer to a plot on a 2-axis or 3-axis graph. A plot may show a histogram of values along a time axis.

The result values may be arranged in three rows. The top row may represent average values. The middle row may represent minimum values. The bottom row may represent maximum values.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and apparatus for providing a graphical user mechanism for back-evaluating crediting methods with selective replacement are provided. Persons skilled in the art will appreciate that the present invention can be practiced by other than the described embodiments, which are presented for purposes of illustration rather than of limitation, and that the present invention is limited only by the claims that follow.

What is claimed is:

1. A graphical user mechanism (“GUM”) for back-evaluating potential crediting methods, the GUM comprising:
a first and a second database stored in a non-transitory memory, the first database comprising a set of historical financial data mapped to a set of dates, and the second database comprising a set of premiums, a first set of replacement values, and a second set of replacement values, the first and second sets of replacement values each being mapped to the set of premiums; and
a first and a second fusion matrix stored in the non-transitory memory, each fusion matrix for determining a final percentage yield (“y_{f}”) based on a premium, a first date, and a second date, the first fusion matrix using the first set of replacement values, and the second fusion matrix using the second set of replacement values;
wherein the GUM is configured to:
receive, via an input/output (“I/O”) component:
a first selected premium, said first selected premium being selected from the set of premiums;
a first start date (“t₀”), said first to being selected from the set of dates; and
a first end date (“t₁”), said first t₁ being selected from the set of dates;
calculate, via a processor, a first y_{f} as determined by the first fusion matrix, using the first selected premium, the first t₀, and the first t₁;
calculate, via the processor, a second y_{f} as determined by the second fusion matrix, using the first selected premium, the first t₀, and the first t₁;
present a graph, on a graphical display, showing the first y_{f} and the second y_{f} as a function of the first selected premium, the first t₀, and the first t₁;
receive, via the I/O component:
a second selected premium, said second selected premium being selected from the set of premiums;
a second t₀, said second t₀ being selected from the set of dates; and
a second t₁, said second t₁ being selected from the set of dates; and
in response to a predetermined trigger:
calculate, via the processor, a third y_{f} as determined by the first fusion matrix, using the second selected premium, the second t₀, and the second t₁;
calculate, via the processor, a fourth y_{f} as determined by the second fusion matrix, using the second selected premium, the second t₀, and the second t₁; and
update the graph, on the graphical display, to show the third y_{f} and the fourth y_{f} as a function of the second selected premium, the second t₀, and the second t₁.

2. The GUM of claim 1, wherein the first and second fusion matrices comprise a monthly point-to-point (“M-PTP”) crediting method, wherein a monthly return value (“r[t]”) for a given month (“t”) out of a 12-month period is calculated by dividing an index value at a valuation date of the given month by an index value at a valuation date of the month before the given month to yield a ratio, and further subtracting 100% from the ratio to yield a monthly return value, wherein each valuation date is a predetermined monthly anniversary date, and the index value at a valuation date is the value of a predetermined financial index at closing on the valuation date, wherein said calculation for said r[t] is at least in part represented by the equation:
$$r [ t ] = \frac{{Index}_{t}}{{Index}_{t - 1}} - 100 \% .$$

3. The GUM of claim 2 wherein the first fusion matrix further comprises a “Cliquet” capping methodology.

4. The GUM of claim 3, wherein the Cliquet capping methodology comprises updating a set comprising the monthly return values of each month of the 12-month period by replacing, each monthly return value in the set that is above a predetermined replacement value, with said replacement value, the Cliquet capping methodology further comprising summing the values in the updated set to yield a total percentage, and determining y_{f} as the greater of 0% and the total percentage.

5. The GUM of claim 4, wherein the first fusion matrix determines y_{f} at least in part using the equation:
y_{f}=Max(Σₜ₌₁¹² min[Cap,r[t]],0).

6. The GUM of claim 2 wherein the second fusion matrix comprises a “Selective Replacement” methodology.

7. The GUM of claim 6, wherein the Selective Replacement methodology comprises updating a set comprising the monthly return values of each month of the 12-month period, said updating by replacing a predetermined number of the highest monthly return values in the set with said replacement value, the Selective Replacement methodology further comprising summing the values in the updated set to yield a total percentage, and determining y_{f} as the greater of 0% and the total percentage.

8. The GUM of claim 7, wherein the second fusion matrix determines y_{f} at least in part using the equation:
y_{f}=Max(Σₜ₌₁^{12-NOR}r_ranked(t)+RL×NOR,0).

9. The GUM of claim 1, wherein the processor calculates each y_{f} in real-time.

10. The GUM of claim 1, wherein the processor pre-calculates at least some of the values used to calculate each y_{f}.

11. The GUM of claim 1, further comprising a refresh button on the graphical display, and the predetermined trigger includes selecting the refresh button.

12. The GUM of claim 1, wherein the graph on the graphical display comprises:
a first column containing values associated with the first fusion matrix; and
a second column containing values associated with the second fusion matrix.

13. The GUM of claim 12, wherein the graph on the graphical display further comprises:
a first row containing average values;
a second row containing minimum values; and
a third row containing maximum values.

14. The GUM of claim 1, further comprising an intelligent module, said intelligent module that uses artificial intelligence technology to analyze the data in the databases to determine a current preferred selection between the first fusion matrix and the second fusion matrix.

15. One or more non-transitory computer-readable media storing computer-executable instructions which, when executed by a processor on a computer system, perform a method for providing interactive back-evaluating of potential crediting methods, the method comprising:
receiving, via an input/output (“I/O”) component of the computer system:
a first selected premium, said first selected premium being selected from a set of premiums stored in the non-transitory computer-readable media, said set of premiums being mapped to both a first and a second set of replacement values;
a first start date (“t₀”), said first to being selected from a set of dates stored in the non-transitory computer-readable media said set of dates being mapped to a set of historical financial data; and
a first end date (“t₁”), said first t₁ being selected from the set of dates;
calculating, via the processor, a first final percentage yield (first “y_{f}”) using a first fusion matrix, said first fusion matrix using the first set of replacement values for determining a y_{f} based on a selected premium, a t₀, and a t₁;
calculating, via the processor, a second y_{f} using a second fusion matrix, said second fusion matrix using the second set of replacement values for determining a y_{f} based on a selected premium, a t₀, and a t₁;
presenting a graph, on a graphical display, showing one or more values of the first y_{f} and the second y_{f} as a function of the first selected premium, the first t₀, and the first t₁;
receiving, via the I/O component:
a second selected premium, said second selected premium being selected from the set of premiums;
a second t₀, said second t₀ being selected from the set of dates; and
a second t₁, said second t₁ being selected from the set of dates; and
in response to a predetermined trigger:
calculating, via the processor, a third y_{f} as determined by the first fusion matrix, using the second selected premium, the second t₀, and the second t₁;
calculating, via the processor, a fourth y_{f} as determined by the second fusion matrix, using the second selected premium, the second t₀, and the second t₁; and
updating the graph, on the graphical display, to show one or more values of the third y_{f} and the fourth y_{f} as a function of the second selected premium, the second t₀, and the second t₁.

16. The computer-readable media of claim 15 wherein, in the method, calculating each y_{f} includes:
calculating a monthly return value (“r[t]”) for a given month (“t”) out of a 12-month period by dividing an index value at a valuation date of the given month by an index value at a valuation date of the month before the given month to yield a ratio, and further subtracting 100% from the ratio to yield a monthly return value, wherein each valuation date is a predetermined monthly anniversary date, and the index value at a valuation date is the value of a predetermined financial index at closing on the valuation date.

17. The computer-readable media of claim 16 wherein, in the method, calculating y_{f} using the first fusion matrix further includes a first replacement methodology, said first replacement methodology comprising:
updating a set comprising the monthly return values of each month of the 12-month period by replacing, each monthly return value in the set that is above a predetermined replacement value, with said replacement value;
summing the values in the updated set to yield a total percentage; and
determining y_{f} as the greater of 0% and the total percentage.

18. The computer-readable media of claim 16 wherein, in the method, calculating y_{f} using the second fusion matrix further includes a second replacement methodology, said second replacement methodology comprising:
updating a set comprising the monthly return values of each month of the 12-month period, said updating by replacing a predetermined number of the highest monthly return values in the set with said replacement value;
summing the values in the updated set to yield a total percentage; and
determining y_{f} as the greater of 0% and the total percentage.

19. A graphical user mechanism (“GUM”) for back-evaluating potential crediting methods, the GUM comprising:
a first and a second database stored in a non-transitory memory, the first database comprising a set of historical financial data mapped to a set of dates, and the second database comprising a set of premiums, a first set of replacement values, and a second set of replacement values, the first and second sets of replacement values each being mapped to the set of premiums; and
a first and a second fusion matrix stored in the non-transitory memory, each fusion matrix for determining a final percentage yield (“y_{f}”) based on a premium, a first date, and a second date, the first fusion matrix using the first set of replacement values, and the second fusion matrix using the second set of replacement values, wherein:
the first and second fusion matrices comprise a monthly point-to-point (“M-PTP”) crediting method, wherein a monthly return value (“r[t]”) for a given month (“t”) out of a 12-month period is calculated by dividing an index value at a valuation date of the given month by an index value at a valuation date of the month before the given month to yield a ratio, and further subtracting 100% from the ratio to yield a monthly return value, wherein each valuation date is a predetermined monthly anniversary date, and the index value at a valuation date is the value of a predetermined financial index at closing on the valuation date;
the first fusion matrix further comprises a “Cliquet” capping methodology, wherein the Cliquet capping methodology comprises updating a set comprising the monthly return values of each month of the 12-month period by replacing, each monthly return value in the set that is above a predetermined replacement value, with said replacement value, the Cliquet capping methodology further comprising summing the values in the updated set to yield a total percentage, and determining y_{f} as the greater of 0% and the total percentage; and
the second fusion matrix comprises a “Selective Replacement” methodology, wherein the Selective Replacement methodology comprises updating a set comprising the monthly return values of each month of the 12-month period, said updating by replacing a predetermined number of the highest monthly return values in the set with said replacement value, the Selective Replacement methodology further comprising summing the values in the updated set to yield a total percentage, and determining y_{f} as the greater of 0% and the total percentage;
wherein the GUM is configured to:
receive, via an input/output (“I/O”) component:
a first selected premium, said first selected premium being selected from the set of premiums;
a first start date (“t₀”), said first to being selected from the set of dates; and
a first end date (“t₁”), said first t₁ being selected from the set of dates;
calculate, via a processor, a first y_{f} as determined by the first fusion matrix, using the first selected premium, the first t₀, and the first t₁;
calculate, via the processor, a second y_{f} as determined by the second fusion matrix, using the first selected premium, the first t₀, and the first t₁;
present a plot, on a graphical display, showing the first y_{f} and the second y_{f} as a function of the first selected premium, the first t₀, and the first t₁;
receive, via the I/O component:
a second selected premium, said second selected premium being selected from the set of premiums;
a second t₀, said second t₀ being selected from the set of dates; and
a second t₁, said second t₁ being selected from the set of dates; and
in response to a predetermined trigger:
calculate, via the processor, a third y_{f} as determined by the first fusion matrix, using the second selected premium, the second t₀, and the second t₁;
calculate, via the processor, a fourth y_{f} as determined by the second fusion matrix, using the second selected premium, the second t₀, and the second t₁; and
update the plot, on the graphical display, to show the third y_{f} and the fourth y_{f} as a function of the second selected premium, the second t₀, and the second t₁.

20. The GUM of claim 19, further comprising a refresh button on the graphical display, and the predetermined trigger includes a selecting of the refresh button.
